(19) United States
(12) Patent Application Publication
(10) Pub. No.: US 2026/0046016 A1
(43) Pub. Date: Feb. 12, 2026

(54) SWITCHING BETWEEN STORE AND FORWARD AND NORMAL MODE OPERATIONS

(71) Applicant: QUALCOMM Incorporated, San Diego, CA (US)

(72) Inventors: Bharat SHRESTHA, San Diego, CA (US); Umesh PHUYAL, San Diego, CA (US); Masato KITAZOE, Hachiouji-shi (JP)

(21) Appl. No.: 19/279,879

(22) Filed: Jul. 24, 2025

Related U.S. Application Data
(60) Provisional application No. 63/679,919, filed on Aug. 6, 2024.

(51) Int. Cl. H04B 7/185

(52) U.S. Cl. CPC H04B 7/1851

(57) ABSTRACT

Methods, systems, and devices for wireless communications are described. A user equipment (UE) may receive, from a satellite network entity, signaling that includes a first indicator of a cell-barred operation status indicative of whether a set of UEs is barred from communications and a second indicator of whether a store and forward operation mode is available for communications. A UE that receives such signaling may evaluate a combination of a first value for the first indicator and a second value of the second indicator and determine an availability of the satellite network entity for communication. The combination of values may be used by the UE to determine whether to initiate connections or communications, refrain from communicating, or communicate in accordance with a store and forward mode. Additionally, the satellite network entity may update the indications in response to a condition associated with a feeder link connection changing.

### CROSS REFERENCES

The present application for patent claims benefit of U.S. Provisional Patent Application No. 63/679,919 by SHRESTHA et al., entitled “SWITCHING BETWEEN STORE AND FORWARD AND NORMAL MODE OPERATIONS,” filed Aug. 6, 2024, assigned to the assignee hereof, and expressly incorporated by reference herein.

### FIELD OF TECHNOLOGY

The following relates to wireless communications, including switching between “store and forward” and normal mode operations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Wireless communications system may support non-terrestrial network communications which may involve a satellite based network entity communicating with UEs. Satellite network entities may experience intermittent connections with ground based networks due to the movement of the satellites and/or the rotation of Earth.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, from a satellite network entity, signaling including a first indicator of a cell-barred operation status indicative of whether a set of UEs is barred from communications with the satellite network entity and a second indicator of whether a store and forward operation mode is available for communications with the satellite network entity, evaluating a combination of a first value for the first indicator and a second value of the second indicator, determining an availability of the satellite network entity for communication with the UE based on the combination of the first value and the second value, and operating in accordance with the availability of the satellite network entity for the communications.

A UE for wireless communications is described. The UE may include one or more memories storing processor executable code, and one or more processors coupled with the one or more memories. The one or more processors may individually or collectively be operable to execute the code to cause the UE to receive, from a satellite network entity, signaling including a first indicator of a cell-barred operation status indicative of whether a set of UEs is barred from communications with the satellite network entity and a second indicator of whether a store and forward operation mode is available for communications with the satellite network entity, evaluate a combination of a first value for the first indicator and a second value of the second indicator, determine an availability of the satellite network entity for communication with the UE based on the combination of the first value and the second value, and operate in accordance with the availability of the satellite network entity for the communications.

Another UE for wireless communications is described. The UE may include means for receiving, from a satellite network entity, signaling including a first indicator of a cell-barred operation status indicative of whether a set of UEs is barred from communications with the satellite network entity and a second indicator of whether a store and forward operation mode is available for communications with the satellite network entity, means for evaluating a combination of a first value for the first indicator and a second value of the second indicator, means for determining an availability of the satellite network entity for communication with the UE based on the combination of the first value and the second value, and means for operating in accordance with the availability of the satellite network entity for the communications.

A non-transitory computer-readable medium storing code for wireless communications is described. The code may include instructions executable by one or more processors to receive, from a satellite network entity, signaling including a first indicator of a cell-barred operation status indicative of whether a set of UEs is barred from communications with the satellite network entity and a second indicator of whether a store and forward operation mode is available for communications with the satellite network entity, evaluate a combination of a first value for the first indicator and a second value of the second indicator, determine an availability of the satellite network entity for communication with the UE based on the combination of the first value and the second value, and operate in accordance with the availability of the satellite network entity for the communications.

In some examples of the method, user equipment (UEs), and non-transitory computer-readable medium described herein, determining the availability may include operations, features, means, or instructions for determining, based on the combination of the first value and the second value, an operation mode by the satellite network entity for communication with the UE, where the operation mode may be determined from the store and forward operation mode and a mode different from the store and forward operation mode.

In some examples of the method, user equipment (UEs), and non-transitory computer-readable medium described herein, receiving the signaling may include operations, features, means, or instructions for receiving the first value that indicates that the set of UEs may be barred from communications with the satellite network entity and the second value that indicates that the store and forward operation mode may be available for the communications with the satellite network entity.

In some examples of the method, user equipment (UEs), and non-transitory computer-readable medium described herein, receiving the signaling may include operations, features, means, or instructions for receiving the first value that indicates that the set of UEs may be not barred from communications with the satellite network entity and the second value that indicates that the store and forward operation mode may be available for the communications with the satellite network entity.

In some examples of the method, user equipment (UEs), and non-transitory computer-readable medium described herein, the combination of the first value and the second value indicates that the store and forward operation mode may be inactive for the satellite network entity.

In some examples of the method, user equipment (UEs), and non-transitory computer-readable medium described herein, the combination of the first value and the second value indicates that the store and forward operation mode may be supported by the satellite network entity and that a feeder link may be available by the satellite network entity.

In some examples of the method, user equipment (UEs), and non-transitory computer-readable medium described herein, operating in accordance with the availability may include operations, features, means, or instructions for communicating with the satellite network entity in accordance with the store and forward operation mode and receiving, from the satellite network entity, signaling that may be configured to cause the UE to perform cell search and cell selection for communications in accordance with a mode different from the store and forward operation mode.

In some examples of the method, user equipment (UEs), and non-transitory computer-readable medium described herein, receiving the signaling may include operations, features, means, or instructions for receiving the first value that indicates that the set of UEs may be not barred from communications with the satellite network entity and the second value that indicates that the store and forward operation mode may be not supported by the satellite network entity.

In some examples of the method, user equipment (UEs), and non-transitory computer-readable medium described herein, operating in accordance with the availability of the satellite network entity may include operations, features, means, or instructions for communicating with the satellite network entity in accordance with a mode different from the store and forward operation mode based on the combination of the first value indicating that the set of UEs may be not barred from communications and the second value indicating that the store and forward operation mode not being supported by the satellite network entity.

In some examples of the method, user equipment (UEs), and non-transitory computer-readable medium described herein, receiving the signaling may include operations, features, means, or instructions for receiving the first value that indicates that the set of UEs may be barred from communications with the satellite network entity and the second value that indicates that the store and forward operation mode may be not supported by the satellite network entity.

In some examples of the method, user equipment (UEs), and non-transitory computer-readable medium described herein, receiving the signaling may include operations, features, means, or instructions for receiving the first value that indicates that the set of UEs may be barred from communications with the satellite network entity and the second value that indicates that the store and forward operation mode may be active for the communications.

In some examples of the method, user equipment (UEs), and non-transitory computer-readable medium described herein, receiving the signaling may include operations, features, means, or instructions for receiving the first value that indicates that the set of UEs may be barred from communications with the satellite network entity and the second value that indicates that the store and forward operation mode may be unavailable for the communications.

In some examples of the method, user equipment (UEs), and non-transitory computer-readable medium described herein, receiving the signaling may include operations, features, means, or instructions for receiving the first value that indicates that the set of UEs may be not barred from communications with the satellite network entity and the second value that indicates that the store and forward operation mode may be barred.

In some examples of the method, user equipment (UEs), and non-transitory computer-readable medium described herein, the combination of the first value and the second value indicates that UEs operating in accordance with the store and forward operation mode may be barred.

In some examples of the method, user equipment (UEs), and non-transitory computer-readable medium described herein, receiving the signaling may include operations, features, means, or instructions for receiving the first value that indicates that cell-barring may be unavailable for the set of UEs and the second value that indicates that the store and forward operation mode may be active for the satellite network entity.

In some examples of the method, user equipment (UEs), and non-transitory computer-readable medium described herein, receiving the signaling may include operations, features, means, or instructions for receiving the first value that indicates that cell-barring may be unavailable for the set of UEs and the second value that indicates that the store and forward operation mode may be inactive for the satellite network entity.

In some examples of the method, user equipment (UEs), and non-transitory computer-readable medium described herein, receiving the signaling may include operations, features, means, or instructions for receiving a system information message that includes the first indicator and the second indicator.

A method for wireless communications by a satellite network entity is described. The method may include detecting a condition indicative of a change in a connection status of a connection between the satellite network entity and a ground station, updating, based on detecting the condition indicative of the change, one or more of a first indicator of a cell-barred operation status indicative of whether a set of UEs is barred from communications with the satellite network entity and a second indicator of whether communications by the satellite network entity are to be performed in accordance with a store and forward operation mode, and transmitting signaling indicative of the updates to one or more of the first indicator and the second indicator.

A satellite network entity for wireless communications is described. The satellite network entity may include one or more memories storing processor executable code, and one or more processors coupled with the one or more memories. The one or more processors may individually or collectively be operable to execute the code to cause the satellite network entity to detect a condition indicative of a change in a connection status of a connection between the satellite network entity and a ground station, updating, base at least in part on detecting the condition indicative of the change, one or more of a first indicator of a cell-barred operation status indicative of whether a set of UEs is barred from communications with the satellite network entity and a second indicator of whether communications by the satellite network entity are to be performed in accordance with a store and forward operation mode, and transmit signaling indicative of the updates to one or more of the first indicator and the second indicator.

Another satellite network entity for wireless communications is described. The satellite network entity may include means for detecting a condition indicative of a change in a connection status of a connection between the satellite network entity and a ground station, means for updating, based on detecting the condition indicative of the change, one or more of a first indicator of a cell-barred operation status indicative of whether a set of UEs is barred from communications with the satellite network entity and a second indicator of whether communications by the satellite network entity are to be performed in accordance with a store and forward operation mode, and means for transmitting signaling indicative of the updates to one or more of the first indicator and the second indicator.

A non-transitory computer-readable medium storing code for wireless communications is described. The code may include instructions executable by one or more processors to detect a condition indicative of a change in a connection status of a connection between the satellite network entity and a ground station, updating, base at least in part on detecting the condition indicative of the change, one or more of a first indicator of a cell-barred operation status indicative of whether a set of UEs is barred from communications with the satellite network entity and a second indicator of whether communications by the satellite network entity are to be performed in accordance with a store and forward operation mode, and transmit signaling indicative of the updates to one or more of the first indicator and the second indicator.

In some examples of the method, satellite network entities, and non-transitory computer-readable medium described herein, detecting the condition may include operations, features, means, or instructions for establishing the connection between the satellite network entity and the ground station, where the first indicator may be updated to indicate that set of UEs may be not barred from the communications, the second indicator may be updated to indicate that the store and forward operation mode may be inactive, or a combination thereof.

In some examples of the method, satellite network entities, and non-transitory computer-readable medium described herein, transmitting the signaling may include operations, features, means, or instructions for transmitting the signaling to cause a UE to initiate a tracking area update procedure when the store and forward operation mode becomes inactive in response to the connection being established.

In some examples of the method, satellite network entities, and non-transitory computer-readable medium described herein, detecting the condition may include operations, features, means, or instructions for determining that the connection between the satellite network entity and the ground station may be to be dropped, where the first indicator may be updated to indicate that the set of UEs may be barred from the communications, the second indicator may be updated to indicate that the store and forward operation mode may be active, or a combination thereof.

In some examples of the method, satellite network entities, and non-transitory computer-readable medium described herein, transmitting the signaling may include operations, features, means, or instructions for transmitting the signaling that releases the set of UEs from a connected state.

Some examples of the method, satellite network entities, and non-transitory computer-readable medium described herein may further include operations, features, means, or instructions for obtaining, for a UE, a capability of the UE to operate in accordance with the store and forward operation mode, where the signaling may be configured to release the UE from a connected state based on the capability.

In some examples of the method, satellite network entities, and non-transitory computer-readable medium described herein, transmitting the signaling may include operations, features, means, or instructions for transmitting one or more messages associated with a system information update procedure, where the one or more messages may be indicative of the updates to the one or more of the first indicator and the second indicator.

In some examples of the method, satellite network entities, and non-transitory computer-readable medium described herein, transmitting the signaling may include operations, features, means, or instructions for transmitting an indication of a cell stop time associated with the drop of the connection between the satellite network entity and the ground station.

In some examples of the method, satellite network entities, and non-transitory computer-readable medium described herein, the indication of the cell stop time indicates that the satellite network entity may be to operate in accordance with the store and forward operation mode after the cell stop time.

In some examples of the method, satellite network entities, and non-transitory computer-readable medium described herein, transmitting the signaling may include operations, features, means, or instructions for transmitting a system information message that includes the first indicator and the second indicator.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports switching between store and forward and normal mode operations in accordance with one or more aspects of the present disclosure.

FIG. 2 shows an example of a wireless communications system that supports switching between store and forward and normal mode operations in accordance with one or more aspects of the present disclosure.

FIG. 3 shows an example of a process flow that supports switching between store and forward and normal mode operations in accordance with one or more aspects of the present disclosure.

FIGS. 4 and 5 show block diagrams of devices that support switching between store and forward and normal mode operations in accordance with one or more aspects of the present disclosure.

FIG. 6 shows a block diagram of a communications manager that supports switching between store and forward and normal mode operations in accordance with one or more aspects of the present disclosure.

FIG. 7 shows a diagram of a system including a device that supports switching between store and forward and normal mode operations in accordance with one or more aspects of the present disclosure.

FIGS. 8 and 9 show block diagrams of devices that support switching between store and forward and normal mode operations in accordance with one or more aspects of the present disclosure.

FIG. 10 shows a block diagram of a communications manager that supports switching between store and forward and normal mode operations in accordance with one or more aspects of the present disclosure.

FIG. 11 shows a diagram of a system including a device that supports switching between store and forward and normal mode operations in accordance with one or more aspects of the present disclosure.

FIGS. 12 and 13 show flowcharts illustrating methods that support switching between store and forward and normal mode operations in accordance with one or more aspects of the present disclosure.

### DETAILED DESCRIPTION

Some wireless communications systems may support communications via satellite network entities that support non-terrestrial networks (NTNs). For example, user equipments (UEs) may communicate with satellite network entities, which support communications with the core network via ground based network entities (e.g., ground stations). However, the satellite network entity may have intermittent feeder link connectivity to ground stations due to the rotation of the Earth and/or the movement of the satellite network entities. Additionally, it may not be feasible or cost-effective to deploy ground stations to support continuous connectivity. In such cases, the satellite network entity and the UE may communicate in accordance with a “store and forward” mode. In such cases, the UE may transmit information or data to the satellite network entity, and the satellite network entity may store the information or data until a communication link (e.g., feeder link) is established with a ground station. After establishing the link, the satellite network entity may transmit the stored information to the ground station for communication to the core network. In such cases, the satellite network entities may support informing the UEs in communication with the satellite network entity of the feeder link availability (e.g., to switch to a non-store and forward mode), when a response from the core network is to be received, and/or whether the UE is to perform retransmissions. Additionally, various types of UEs may not support communications in the store and forward mode. However, using system information update procedures to indicate the change in operating modes may be associated with communication resource overhead.

Techniques described herein support signaling to indicate to a UE a mode of operation of a satellite network entity, whether the satellite network entity supports store and forward mode, whether a feeder link is available (and thus the satellite network entity is not operating in accordance with the store and forward mode), and whether any UEs are barred from communications with the satellite network entity. For example, the satellite network entity may transmit, to the UE, signaling (e.g., system information) that includes a first indicator of a cell-barred operation status indicative of whether a set of UEs is barred from communications with the satellite network entity and a second indicator of whether a store and forward operation mode is available for communications with the satellite network entity. A UE that receives such signaling may evaluate a combination of a first value for the first indicator and a second value of the second indicator and determine an availability of the satellite network entity for communication with the UE based on the combination of the first value and the second value. The UE may then operate in accordance with the indications. For example, the UE may determine whether to initiate connections or communications, refrain from communicating, and/or communicate in accordance with a store and forward mode. Additionally, the satellite network entity may update the indications in the system information in response to a condition associated with a feeder link connection changing, such as to notify the UE of feeder link availability or unavailability. These and other techniques are described in further detail with respect to the figures.

Aspects of the disclosure are initially described in the context of wireless communications systems. Aspects of the disclosure are further described with respect to a wireless communications system illustrating an environment whereby a satellite network entity and a UE operate in accordance with a store and forward mode and a process flow illustrating example store and forward mode operations. Aspects of the disclosure are further illustrated by and described with reference to apparatus diagrams, system diagrams, and flowcharts that relate to switching between store and forward and normal mode operations.

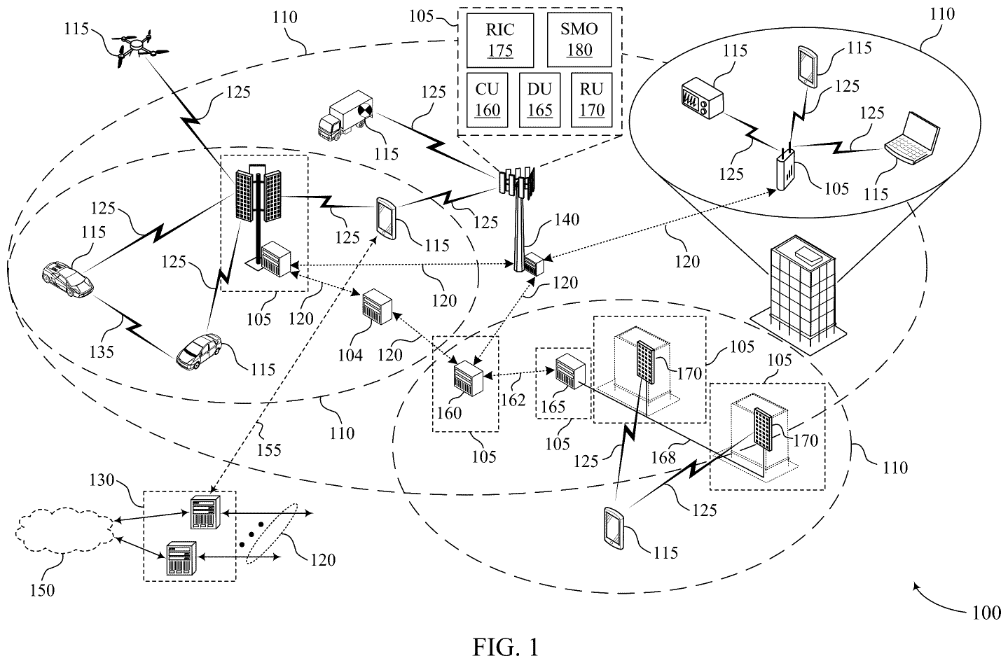

FIG. 1 shows an example of a wireless communications system 100 that supports switching between store and forward and normal mode operations in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-NB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support communications via satellite network entities (e.g., a network entity 105) that support non-terrestrial networks (NTNs). For example, UEs 115 may communicate with satellite network entities, which support communications with the core network via ground based network entities (e.g., ground stations). However, the satellite network entity may have intermittent feeder link connectivity to ground stations due to the rotation of the Earth and/or the movement of the satellite network entities. Additionally, it may not be feasible or cost-effective to deploy ground stations to support continuous connectivity. In such cases, the satellite network entity and the UE 115 may communicate in accordance with a store and forward mode. In such cases, the UE 115 may transmit information or data to the satellite network entity, and the satellite network entity may store the information or data until a communication link (e.g., feeder link) is established with a ground station. After establishing the link, the satellite network entity may transmit the stored information to the ground station for communication to the core network. In such cases, the satellite network entities may support informing the UEs in communication with the satellite network entity of the feeder link availability (e.g., to switch to a non-store and forward mode), when a response from the core network is to be received, and/or whether the UE is to perform retransmissions.

Techniques described herein support signaling to indicate to a UE 115 mode of operation of a satellite network entity (e.g., network entity 105), whether the satellite network entity supports store and forward mode, whether a feeder link is available (and thus the satellite network entity is not operating in accordance with the store and forward mode), and whether any UEs 115 are barred from communications with the satellite network entity. For example, the satellite network entity may transmit, to the UE 115, signaling (e.g., system information) that includes a first indicator of a cell-barred operation status indicative of whether a set of UEs 115 is barred from communications with the satellite network entity and a second indicator of whether a store and forward operation mode is available for communications with the satellite network entity. The UE 115 that receives such signaling may evaluate a combination of a first value for the first indicator and a second value of the second indicator and determine an availability of the satellite network entity for communication with the UE based on the combination of the first value and the second value. The UE 115 may then operate in accordance with the indications. For example, the UE 115 may determine whether to initiate connections or communications, refrain from communicating, and/or communicate in accordance with a store and forward mode. Additionally, the satellite network entity may update the indications in the system information in response to a condition associated with a feeder link connection changing, such as to notify the UE 115 of feeder link availability or unavailability.

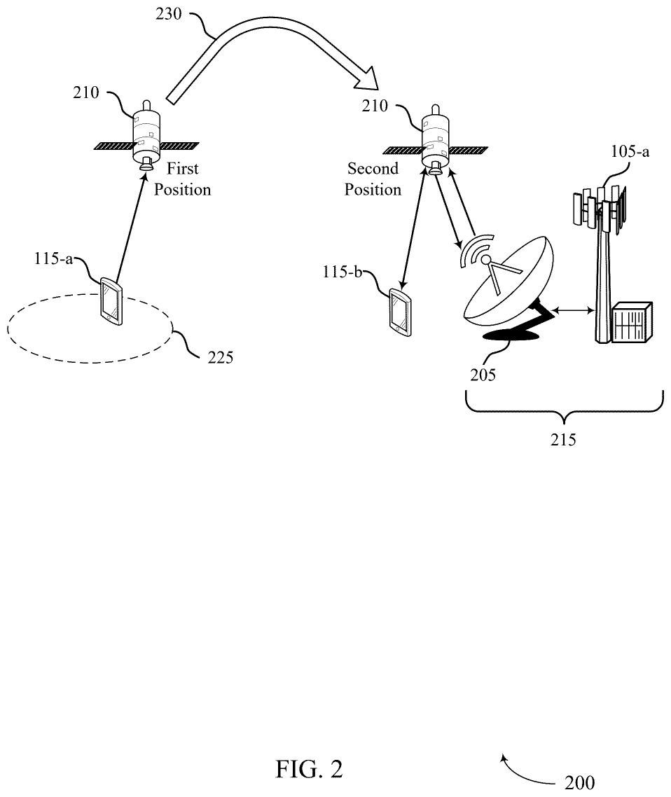

FIG. 2 shows an example of a wireless communications system 200 that supports switching between store and forward and normal mode operations in accordance with one or more aspects of the present disclosure. The wireless communications system 200 includes a UE 115-a, a UE 115-b, a satellite network entity 210, and a ground station 215. The UEs 115-a and 115-b may be examples of the UEs 115 as described with respect to FIG. 1. Additionally, the satellite network entity 210 may be an example of the network entities 105 as described with respect to FIG. 1. The ground station 215 includes an antenna 205 (e.g., a parabolic antenna, such as a dish), and a network entity 105-a, which may be an example of the network entities 105 as described with respect to FIG. 1. While the antenna 205 is shown as a dish, it should be understood that other types of antennae for communications with satellite network entities (e.g., satellite network entity 210) may be implemented. Additionally, the ground station 215 is shown as including the antenna 205 and the network entity 105-a as separate components, but it should be understood that the ground station 215 may be implemented in the same entity (e.g., geolocated) or multiple different entities.

Due to the movement of the satellite network entity 210 (as illustrated by arrow 230) and/or the earth, on which the UEs 115 are positioned, the UEs 115 may experience discontinuous coverage. Additionally, the satellite network entity 210 may experience intermittent feeder link connection (e.g., a communication link between the satellite network entity 210 and a ground station, such as ground station 215). For example, ground stations may not be feasible to deploy in some areas (e.g., due to population sparseness or terrain) and may not be cost effective.

Accordingly, the UEs 115 and the satellite network entity 210 may operate in accordance with a store and forward mode. As illustrated in FIG. 2, the satellite network entity 210 at the first position may communicate with the UE 115-a, but may not have a feeder link connection with a nearby ground station, such as ground station 215. As such, in accordance with the store and forward mode, the UE 115-a may transmit uplink data to the satellite network entity 210. Thus, a coverage area 225 may be referred to a store and forward service area. Thereafter, when the satellite network entity 210 moves to the second position, the satellite network entity 210 communicates the data received from the UE 115-a to the ground station 215 such the data may be transmitted to the core network. Thus, the data is stored while the satellite network entity does not have a feeder link, and the data is forwarded after the satellite network entity 210 establishes the feeder link.

The wireless communications system 200 may support a full mobile management entity (MME) on the satellite network entity 210 or a split MME on the satellite network entity 210. In cases when the satellite network entity 210 includes a split MME, a first portion of the MME procedure may occur on the satellite network entity 210, and a second portion of the MME procedure may occur via communications with the ground station 215. Additionally, in a scenario when the wireless communications system 200 supports a split MME architecture, when the UE 115 initiates an attach or tracking area update (TAU) procedure, the UE 115 may indicate whether the UE 115 supports the store and forward mode using non-access stratum (NAS) capability. In response to receiving the NAS capability signaling, the MME may send an attach or TAU reject message to the UE if these procedures cannot be completed due to the store and forward operation. The rejection message may also indicate that the UE may re-attempt the attach or TAU in the public land mobile network (PLMN) in a next satellite pass. This signaling indicates that information contained in the attach request message is stored by the MME and that the network may be available to the UE 115 after interaction with the ground network via a ground station (e.g., the ground station 215). The reject message may include an indication of a wait timer, which indicates to the UE 115 the time the UE 115 should wait before re-attempting the attach/Tau procedure in the current or another satellite of the same PLMN. Optionally, the satellite network entity 210 may signal (e.g., via the reject message) a list of satellite identifiers over which the UE 115 may re-attempt the attach/TAU procedure after the wait timer expires. The satellite identifiers may be based on the system information block (SIB) information broadcast by a network entity.

Additionally, the satellite network entity 210 may be configured with a base station network entity and a core network entity that are configured to provide various functionality. For example, the core network entity of the satellite network entity 210 may have access to the capabilities of the UEs 115. Additionally, the base station network entity of the satellite network entity 210 may perform actions based on the UE capabilities. For example, the base station network entity of the satellite network entity 210 may release UEs from a connected state when the feeder link is to become unavailable. In such cases, the base station network entity may obtain the capability information for the connected mode UEs from the core network entity such as to identify UEs that are to be released.

In some cases, an indication of a store and forward mode may be carried via information in SIB signaling. Additionally, some UEs 115 may be subject to barring via a cell-barring indication (e.g., terrestrial network cell-barring) or a non-terrestrial network (NTN) cell-barring indication. In the store a forward mode, the UE may support the wait timer before re-attempting the attach/TAU procedure. However, when the satellite network entity 210 moves to a region to establish a feeder link connection, the satellite network entity may operate in accordance with a normal mode (e.g., non-store and forward mode). However, a system information update procedure to notify UEs 115 regarding the change may be costly in terms of energy and resource overhead. Techniques described herein support signaling to switch between store and forward mode operation and normal mode operation.

Various types of signaling may be used to support indicating store and forward mode support, store and forward mode operation, feeder link available, etc. In accordance with a first option, the satellite network entity 210 that supports store and forward mode operation may broadcast (e.g., via a store and forward mode indicator in system information) that the satellite network entity 210 is operating in accordance with the store and forward mode. In this example, it is transparent to the UE 115-a whether the satellite has a feeder link connection or not (assuming the UE 115-a supports communications in the store and forward mode). That is, if the satellite network entity 210 indicates that the satellite network entity 210 is operating in accordance with the store and forward mode, then the satellite network entity 210 does not have a feeder link connection. Alternatively, the satellite network entity 210 indicates that it is operating in accordance with a non-store and forward mode, then the satellite network entity 210 has a feeder link connection. In this example, the satellite network entity 210 may use cell-barring signaling (e.g., a cell-barring indicator) to indicate whether some UEs 115 are barred from connecting with the satellite network entity 210. In some examples, if a UE is able to identify the store and forward mode indication but does not support communications in accordance with the store and forward mode, then such UEs 115 may not select to the cell that is broadcasting the store and forward mode indication.

If the satellite network entity 210 is operating with no feeder link, then the satellite network entity 210 may operate in accordance with the store and forward mode and may provide reject messages with the wait time and a list of satellite identifiers. In scenarios when the feeder link is available, then the cell operates in accordance with a non-store and forward mode, the satellite network entity 210 may still broadcast the store and forward mode indication. In such cases, the UE 115-a does not receive a reject message when trying to connect but instead attaches and accepts or receives a tracking area update (TAU) complete message (e.g., the UE 115-a does not receive or utilize a wait timer). As the store and forward mode indication may not be changed in the SIB, the benefit of a system information update procedure may not be received or used, which may result in less communication resource overhead relative to a system information update procedure. This technique may mean that the cell-barring bits are set to bar UEs 115 that do not support store and forward communications. Additionally, UEs 115 that support store and forward mode may ignore the cell-barring bits if the store and forward indication is present.

In accordance with an alternative option to the first option, the store and forward indication may be updated by network implementation without notifying the UEs via a system information update procedure. However, if the cell-barring bit (e.g., call-barring indicator) is changed, then the system information update procedure may be used. In accordance with this option, when the feeder link is available at the satellite network entity 210, then the store and forward indication bit may not be broadcast. When the feeder link is not available, then the store and forward indication (e.g., store and forward indication bit) may be broadcast via system information.

The following table 1 summarizes various signaling and statuses in accordance with the first option:

TABLE 1

| NTN Barring | S&F Indication | Status |
|---|---|---|
| Present | Not present | Legacy NTN cell. The S&F |
| | | mode operation is not |
| | | supported, but UEs supporting |
| | | the S&F mode can access the |
| | | cell. |
| Barred | Present | S&F mode supporting UEs may |
| | | access the cell. |
| Not Barred | Present | Cell supports S&F mode and |
| | | has feeder link. NTN capable |
| | | UEs may access the cell. |
| Not present | Not present | Not a NTN cell. |

In Table 1, a legacy non-terrestrial network (NTN) cell refers to a cell (e.g., network entity) that does not support store and forward (S&F) mode operation. Further, a legacy UE refers to a UE that does not support store and forward mode operation. Additionally, “present” refers to the indication being present, but the status may not be dependent on the value of the actual indication. Moreover, “not present” may mean that that the indication is not present in system information (but there may be an indication that the store and forward mode indication is not present). A NTN cell may refer to a terrestrial cell, such as a grounded network entity cell.

As described herein, the S&F indication and the barring indication may be included in the system information. In accordance with a second proposal, the barring indication (bit) may not be ignored, and the store and forward mode indication is a store and forward barring indication. In this example, the UEs 115 may initially check the cell-barring indication. If the cell is barred, then the cell is barred for NTN capable UEs 115 if the store and forward indication is not present. If the cell is barred in accordance with the indication and the store and forward indication is present, then legacy UEs 115 may be barred. That is, the UEs 115 that support store and forward mode operation may further check the store and forward specific barring indication (store and forward barring indicator) to determine an action, such as to operate in accordance with the store and forward mode or a non-store and forward mode. If the cell is not barred in accordance with the first bit, then legacy and store and forward mode UEs 115 may camp in the cell.

In accordance with a third option, the store and forward specific barring indication presence may function as an implicit indication of support of store and forward mode. In this case, if the cell supports the store and forward mode, then the store and forward mode indication bit is included. If the cell does not support store and forward mode operation, the store and forward mode indication is not included, and the cell is to have a feeder connection for communications with the UEs 115. If the store and forward mode indication indicates that the store and forward mode is barred, then the cell supports store and forward mode operation, but the cell is barred for UEs operating in accordance with the store and forward mode. If the store and forward mode indication indicates that the cell is operating in accordance with the store and forward mode, then the cell supports store and forward mode operation (because of the presence of the indication), and the cell is not barred for UEs 115 operating in accordance with the store and forward mode.

The following table 2 illustrates example signaling and status in accordance with the second and third option:

TABLE 2

| NTN Barring | S&F Barring Indication | Status |
|---|---|---|
| Not present | N/A | This not an NTN cell. NTN |
| | | access unavailable in the cell. |
| Barred/Not | Not present | Legacy NTN cell. The S&F |
| Barred | | mode operation is not |
| | | supported. |
| Barred | Not Barred | S&F mode supporting UEs may |
| | | access the cell. Cell has no |
| | | current feeder link. |
| Barred | Barred | No UEs may camp in the cell. |
| Not Barred | Present (Barred/Not | Option #1: NTN capable UEs |
| | barred) | may access the cell. |
| | | Cell supports S&F mode |
| | | operation and feeder link |
| | | connection is available. |
| Not Barred | Barred | Option #2: UEs operating in |
| | | S&F mode is barred. This cell |
| | | may operate is legacy NTN cell. |

The “N/A” in table 2 may mean that the store and forward barring indication does not exist in the system information, and the system information does not include an indication that the store and forward barring indication exists. A “not present” status may mean that there is information in the system information that indicates that store and forward mode barring indication is not present in the system information. Thus, the “not present” status may still function as a store and forward mode indicator. When the cell-barring indication indicates is present (barred or not barred) and the store and forward indication is not present, then the UEs 115 that support store and forward mode may follow the cell-barring indication (e.g., cellBarred-NTN-r17) to determine operations.

In accordance with a fourth option, the system information may include a store and forward indication and the cell-barring indication. However, the cell-barring indication may not be broadcast (e.g., cellBarred-NTN-r17 is not broadcast) in some scenarios. In these scenarios, the legacy UEs are barred for NTN access as the UEs may assume that the cell is barred for NTN. Additionally, the legacy cell-barred indication (non-NTN specific barring) may be set to barred to bar the access for the non-NTN capable UEs. Additionally, the cell may broadcast the store and forward barring indication (e.g., cellAccessRelatedInfo-NTN-r19). The presence of store and forward barring indication may mean that the cell supports only the store and forward mode operation. As such, when no feeder link is available for the cell, the cell may not broadcast the indication that store and forward mode is barred. Instead, the cell may broadcast the cell-barring indication (e.g., cellAccessRelatedInfo-NTN-r17). When changing between store and forward mode operation, the network may ensure that the trackingAreaList parameter remains the same in the cell. The following table 3 illustrates example signaling and status in accordance with the fourth option:

TABLE 3

| | S&F Indication (or | |
|---|---|---|
| NTN Barring | indication) (2 bits) | Status |
| Present (barred/ | Not present | Legacy NTN cell. The S&F |
| not barred) | | mode operation is not |
| | | supported. |
| Not present | Not barred | S&F mode supporting UEs |
| | | may camp in the cell. |
| Not present | Barred | NTN access not available. |
| Not present | Not present | Not a NTN cell. Non-NTN |
| | | capable UEs may access the |
| | | cell depending on the non- |
| | | NTN barring status. |

When the satellite network entity 210 establishes the feeder link connection (e.g., with the ground station 215), the satellite network entity 210 (e.g., the cell) updates the system information and removes the store and forward indication and/or the store and forward specific barring indication. In this example, the cell may not perform any action (e.g., send updated system information) because the UEs supporting store and forward mode operation may all support non-store and forward mode operation (e.g., normal operation).

When the satellite network entity 210 loses the feeder link connection, the cell may update the system information and add a store and forward mode indication and/or indicate that the store and forward mode is not barred. In this example, the cell may release UEs 115 that do not support store and forward mode operation that are in a connected state (e.g., RRC_CONNECTED) so that the UEs 115 enter an idle mode. Further, since UE capability may reported via a NAS message, new signaling may be used between the network entity and the MME for the network entity to be aware of the UE capability. Further, the cell may use the system information update procedure to notify UEs of the change of the store and forward indication. However, in some cases, the network may not notify UEs 115. Legacy UEs (not supporting store and forward mode) may be camping in the cell and may continue to camp and monitor for paging messages until a new SIB1 is acquired. In some cases, the cell may use the cell stop time indication that is broadcast in SIB19, and this cell stop time may indicate when (or an estimate when) the cell is to lose the feeder link connection such that the UEs 115 may operate in the store and forward mode. Thus, the cell stop top indication may be broadcast to notify store and forward mode capable UEs that the cell is to operate in accordance with the store and forward mode at the indicated time.

In some cases, the UEs 115 may be configured with frequency priorities and cell reselection offsets for the purposes of switching between store and forward mode and normal mode operations. These parameters may support defining procedures to perform measurements for cell reselection. In some cases, the UEs 115 that are communicating with store and forward mode cells may be configured to move to cells operating in in normal mode. Additionally, the UEs 115 may prioritize to select to a cell operating in a normal mode over a cell operating in a store and forward mode. For example, narrow band Internet-of-things (NB-IoT) UEs (which may not consider frequency priorities) may prioritize normal mode cells over store and forward mode cells. These techniques may be applicable in cases when equal cell priorities are configured or in cases where cell selection criteria is satisfied for both store and forward mode operations and normal mode cells. When accessing a cell operating a store and forward mode, the UEs may be configured to periodically search for cells operating in a normal mode. Additionally, when switching between store and forward mode and normal mode, UE may be configured to trigger registration or a TAU update. In some examples, the cells operating in a normal mode and the store and forward mode may be configured with the same tracking area or a same PLMN, where no TUA or registration update is performed for cell switching.

As described herein, the satellite network entity 210 may update the indications based on various conditions. For example, when the feeder link connection is established or becomes available, the satellite network entity 210 may remove the store and forward mode indication (e.g., in system information). In such cases, the satellite network entity 210 may not send a notification to the UEs 115 because the UEs supporting store and forward mode operation may also support normal mode operations. However, if the cell-barred status is changed (e.g., cellBarred-NTN-r17 is changed), procedures may be used to update the SIB1. In cases where the feeder link connection s to be dropped such that the store and forward mod indication is added, the satellite network entity 210 may release UEs 115, which do not support store and forward mode, from a RRC_CONNECTED state to a IDLE state. In such cases, the satellite network entity 210 (e.g., the base station entity) may perform the release operation, and the core network entity signals a store and forward mode capability of the UE 115 to the satellite network entity 210. In some examples, the core network entity of the satellite network triggers the release operation. Moreover, in such cases, it may be desirable to avoid transmitting paging notifications to eMTC and NB-IoT UEs. Therefore, cell stop mechanisms may be used to inform the legacy UEs to identify other cells at the indicated cell stop time. This technique may be used in scenarios when the feeder link connection is dropped or added. For UEs supporting store and forward mode operations, a indication (e.g., in SIB1 or SIB19) may be used to indicate the cell stop time associated with store and forward mode operation. For example, at cell stop time, the cell is to lose the feeder link connection and operate in accordance with the store and forward mode.

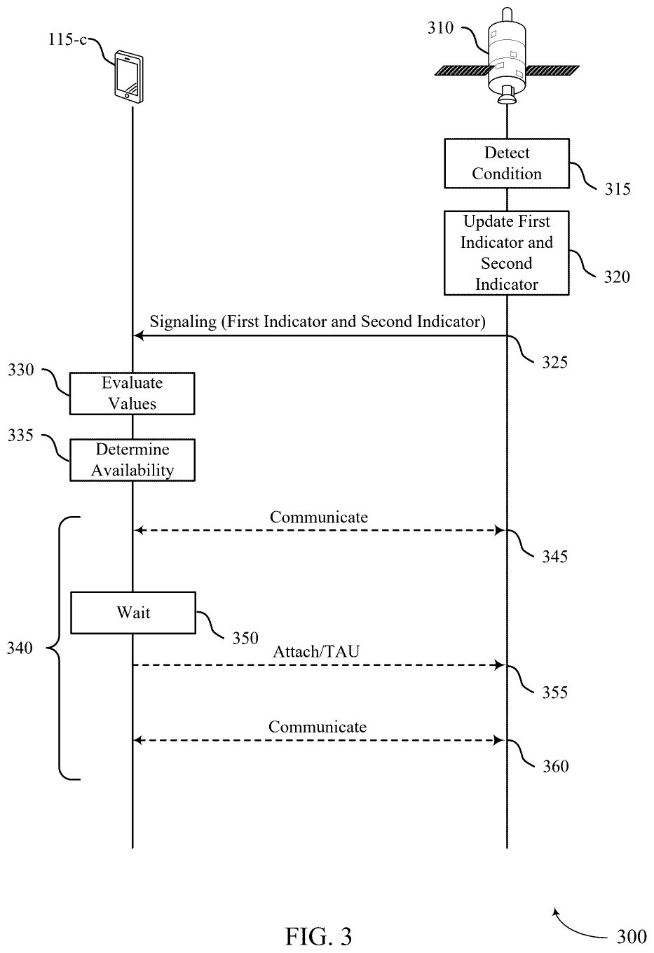

FIG. 3 shows an example of a process flow 300 that supports switching between store and forward and normal mode operations in accordance with one or more aspects of the present disclosure. The process flow 300 includes a UE 115-c and a satellite network entity 310, which may be example of the corresponding device as described herein with reference to FIGS. 1 and 2. Alternative examples of the following may be implemented, where some operations are performed in a different order than described or are not performed at all. In some cases, operations may include additional features not mentioned below, or further operations may be added. Although the UE 115-c and the satellite network entity 310 are shown performing the operations of the process flow 300, some aspects of some operations may also be performed by one or more other components or systems.

At 315, the satellite network entity 310 may detect a condition indicative of a change in a connection status of a connection between the satellite network entity 310 and a ground station. In some cases, detecting of the condition includes establishing the connection between the satellite network entity and the ground station. In some examples, detection of the condition includes determining that the connection between the satellite network entity and the ground station is to be dropped.

At 320, the satellite network entity 310 may update, based at least in part on detecting the condition indicative of the change, one or more of a first indicator of a cell-barred operation status indicative of whether a set of UEs is barred from communications with the satellite network entity and a second indicator of whether communications by the satellite network entity are to be performed in accordance with a store and forward operation mode.

At 325, the satellite network entity 310 may transmit signaling indicative of the updates to one or more of the first indicator and the second indicator. Additionally, at 325, the UE 115-c may receive signaling including a first indicator of a cell-barred operation status indicative of whether a set of UEs is barred from communications with the satellite network entity and a second indicator of whether a store and forward operation mode is available for communications with the satellite network entity.

In some examples, receiving the signaling includes receiving the first value that indicates that the set of UEs is barred from communications with the satellite network entity 310 and the second value that indicates that the store and forward operation mode is available for the communications with the satellite network entity 310.

In some examples, receiving the signaling includes receiving the first value that indicates that the set of UEs is barred from communications with the satellite network entity 310 and the second value that indicates that the store and forward operation mode is available for the communications with the satellite network entity 310. In some examples, the combination of the first value and the second value indicates that the store and forward operation mode is inactive for the satellite network entity 310. Additionally, or alternatively, the combination of the first value and the second value indicates that the store and forward operation mode is supported by the satellite network entity 310 and that a feeder link is available by the satellite network entity 310.

In some examples, receiving the signaling includes receiving the first value that indicates that the set of UEs is barred from communications with the satellite network entity 310 and the second value that indicates that the store and forward operation mode is available for the communications with the satellite network entity 310.

In some examples, receiving the signaling includes receiving the first value that indicates that the set of UEs is barred from communications with the satellite network entity 310 and the second value that indicates that the store and forward operation mode is available for the communications with the satellite network entity 310.

In some examples, receiving the signaling includes receiving the first value that indicates that the set of UEs is barred from communications with the satellite network entity 310 and the second value that indicates that the store and forward operation mode is active for the communications.

In some examples, receiving the signaling includes receiving the first value that indicates that the set of UEs is barred from communications with the satellite network entity 310 and the second value that indicates that the store and forward operation mode is unavailable for the communications.

In some examples, receiving the signaling includes receiving the first value that indicates that the set of UEs is not barred from communications with the satellite network entity 310 and the second value that indicates that the store and forward operation mode is barred. In such cases, the combination of the first value and the second value may indicate that UEs operating in accordance with the store and forward operation mode are barred.

In some examples, receiving the signaling includes receiving the first value that indicates that cell-barring is unavailable for the set of UEs and the second value that indicates that the store and forward operation mode is active for the satellite network entity 310.

In some examples, receiving the signaling includes receiving the first value that indicates that cell-barring is unavailable for the set of UEs and the second value that indicates that the store and forward operation mode is inactive for the satellite network entity 310. The signaling may be received via a system information message.

In some examples, the signaling transmitted by the satellite network entity 310 may be configured to cause the UE to initiate a TAU procedure when the store and forward operation mode becomes inactive in response to the connection (e.g., feeder link connection) being established.

In some cases, the satellite network entity 310 may obtain a capability of the UE to operate in accordance with the store and forward operation mode. In such cases, the signaling may be configured to release the UE from a connected state (e.g., RRC_CONNECTED) based on the capability of the UE 115-c. In such cases, the UE 115-c may enter an idle state.

At 330, the UE 115-c may evaluate a combination of a first value for the first indicator and a second value of the second indicator. The combination may be indicative of whether the cell is available for normal mode communications, store and forward mode communications, a cell-barred status, etc.

At 335, the UE 115-c may determine an availability of the satellite network entity 310 for communication with the UE based at least in part on the combination of the first value and the second value. In some examples, the UE 115-c may determine based at least in part on the combination of the first value and the second value, an operation mode by the satellite network entity for communication with the UE. The operation mode may be determined from the store and forward mode and a mode different from the “store and forward” mode (e.g., a normal mode).

At 340, the UE 115-c may operate in accordance with the availability of the satellite network entity 310 for the communications. Operating in accordance with the availability of the satellite network entity may include communicating, at 345, with the satellite network entity 310. For example, if the indicators indicate that the satellite network entity is operating in accordance with the store and forward mode, then the UE 115-c may communicate with the satellite network entity in accordance with the store and forward mode. As another example, the indicators may indicate that a feeder link is available (e.g., non-store and forward mode), and the UE 115-c may communicate with the satellite network entity 310 via a standard communication mode. In some cases, the indicators may indicate that the UE 115-c is cell barred. In such cases, the UE 115-c may refrain from communicating with the satellite network entity 310. In some cases, the UE 115-c may receive a wait timer (e.g., via the signaling or via a rejection message), and the UE may wait at 350 in accordance with the wait timer. After waiting, the UE 115-c may reattempt, at 355, an attach/TAU procedure and communicate at 360 if the procedure is successful. In some cases, the UE 115-a may communicate in accordance with the store and forward operation mode, and receive signaling that is configured to cause the UE 115-a to perform cell search and sell selection for communications in a mode different from the store and forward operation mode, such as a normal mode.

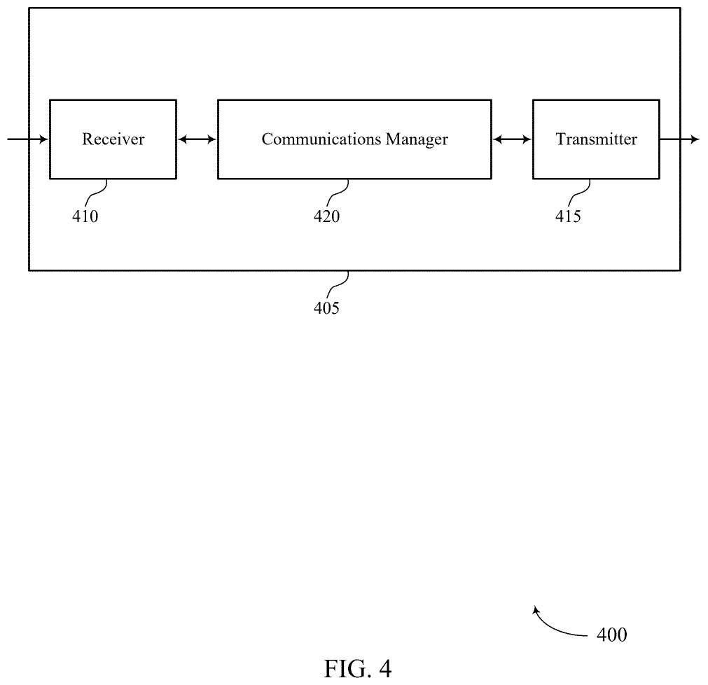

FIG. 4 shows a block diagram 400 of a device 405 that supports switching between store and forward and normal mode operations in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to switching between store and forward and normal mode operations). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to switching between store and forward and normal mode operations). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of switching between store and forward and normal mode operations as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving, from a satellite network entity, signaling including a first indicator of a cell-barred operation status indicative of whether a set of UEs is barred from communications with the satellite network entity and a second indicator of whether a store and forward operation mode is available for communications with the satellite network entity. The communications manager 420 is capable of, configured to, or operable to support a means for evaluating a combination of a first value for the first indicator and a second value of the second indicator. The communications manager 420 is capable of, configured to, or operable to support a means for determining an availability of the satellite network entity for communication with the UE based on the combination of the first value and the second value. The communications manager 420 is capable of, configured to, or operable to support a means for operating in accordance with the availability of the satellite network entity for the communications.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power and processing resource consumption by providing indications of store and forward mode operations and/or cell-barring status such that UEs may reduce processing, communication, and other resource overhead associated with trying to communicate using a normal mode when such a mode is unavailable for communications.

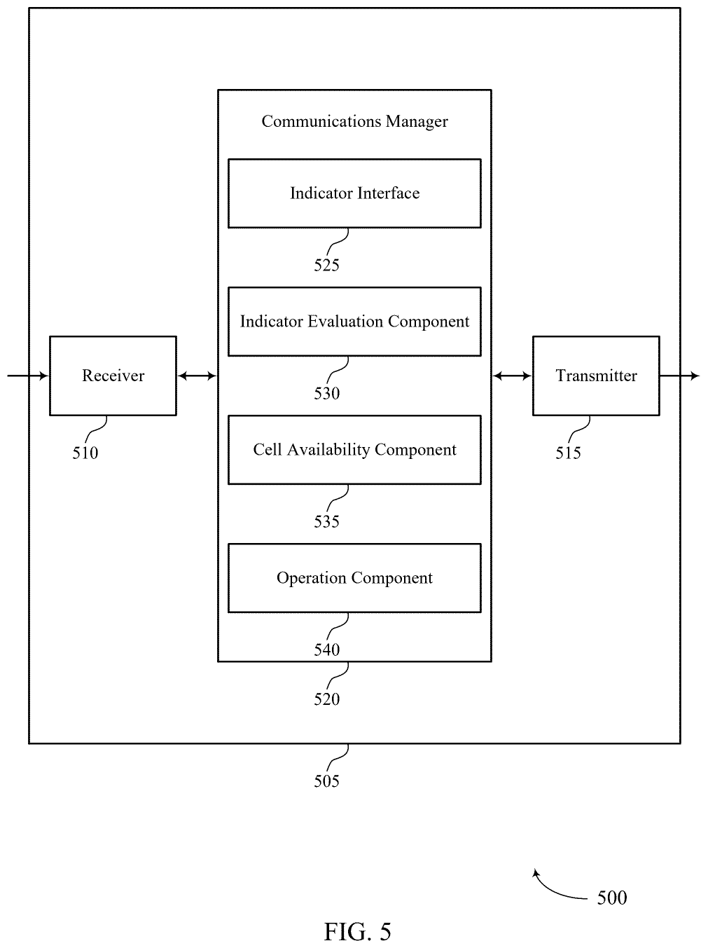

FIG. 5 shows a block diagram 500 of a device 505 that supports switching between store and forward and normal mode operations in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to switching between store and forward and normal mode operations). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to switching between store and forward and normal mode operations). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of switching between store and forward and normal mode operations as described herein. For example, the communications manager 520 may include an indicator interface 525, an indicator evaluation component 530, a cell availability component 535, an operation component 540, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The indicator interface 525 is capable of, configured to, or operable to support a means for receiving, from a satellite network entity, signaling including a first indicator of a cell-barred operation status indicative of whether a set of UEs is barred from communications with the satellite network entity and a second indicator of whether a store and forward operation mode is available for communications with the satellite network entity. The indicator evaluation component 530 is capable of, configured to, or operable to support a means for evaluating a combination of a first value for the first indicator and a second value of the second indicator. The cell availability component 535 is capable of, configured to, or operable to support a means for determining an availability of the satellite network entity for communication with the UE based on the combination of the first value and the second value. The operation component 540 is capable of, configured to, or operable to support a means for operating in accordance with the availability of the satellite network entity for the communications.

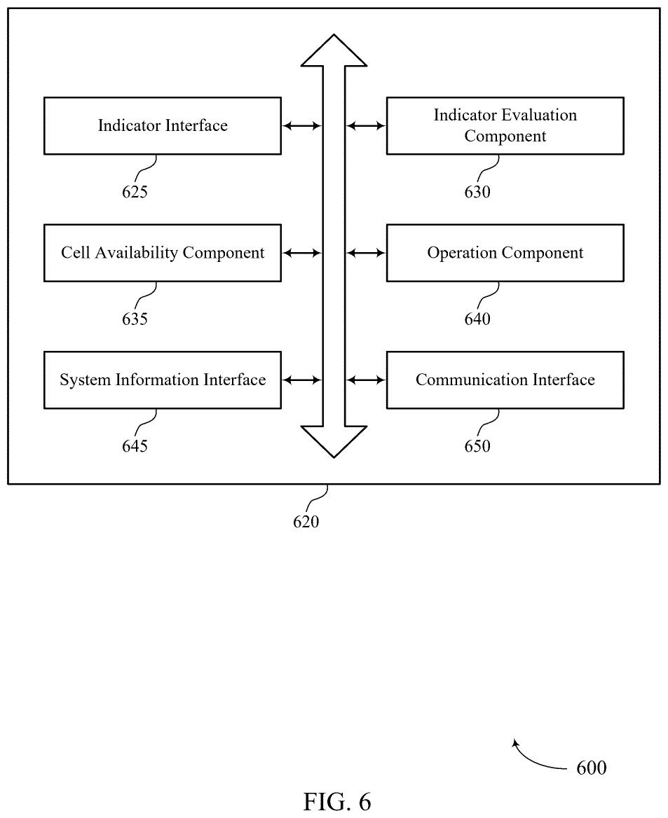

FIG. 6 shows a block diagram 600 of a communications manager 620 that supports switching between store and forward and normal mode operations in accordance with one or more aspects of the present disclosure. The communications manager 620 may be an example of aspects of a communications manager 420, a communications manager 520, or both, as described herein. The communications manager 620, or various components thereof, may be an example of means for performing various aspects of switching between store and forward and normal mode operations as described herein. For example, the communications manager 620 may include an indicator interface 625, an indicator evaluation component 630, a cell availability component 635, an operation component 640, a system information interface 645, a communication interface 650, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The indicator interface 625 is capable of, configured to, or operable to support a means for receiving, from a satellite network entity, signaling including a first indicator of a cell-barred operation status indicative of whether a set of UEs is barred from communications with the satellite network entity and a second indicator of whether a store and forward operation mode is available for communications with the satellite network entity. The indicator evaluation component 630 is capable of, configured to, or operable to support a means for evaluating a combination of a first value for the first indicator and a second value of the second indicator. The cell availability component 635 is capable of, configured to, or operable to support a means for determining an availability of the satellite network entity for communication with the UE based on the combination of the first value and the second value. The operation component 640 is capable of, configured to, or operable to support a means for operating in accordance with the availability of the satellite network entity for the communications.

In some examples, to support determining the availability, the cell availability component 635 is capable of, configured to, or operable to support a means for determining, based on the combination of the first value and the second value, an operation mode by the satellite network entity for communication with the UE, where the operation mode is determined from the store and forward operation mode and a mode different from the store and forward operation mode.

In some examples, to support receiving the signaling, the indicator interface 625 is capable of, configured to, or operable to support a means for receiving the first value that indicates that the set of UEs is barred from communications with the satellite network entity and the second value that indicates that the store and forward operation mode is available for the communications with the satellite network entity.

In some examples, to support receiving the signaling, the indicator interface 625 is capable of, configured to, or operable to support a means for receiving the first value that indicates that the set of UEs is not barred from communications with the satellite network entity and the second value that indicates that the store and forward operation mode is available for the communications with the satellite network entity.

In some examples, the combination of the first value and the second value indicates that the store and forward operation mode is inactive for the satellite network entity.

In some examples, the combination of the first value and the second value indicates that the store and forward operation mode is supported by the satellite network entity and that a feeder link is available by the satellite network entity.

In some examples, to support receiving the signaling, the indicator interface 625 is capable of, configured to, or operable to support a means for receiving the first value that indicates that the set of UEs is not barred from communications with the satellite network entity and the second value that indicates that the store and forward operation mode is not supported by the satellite network entity.

In some examples, to support operating in accordance with the availability of the satellite network entity, the communication interface 650 is capable of, configured to, or operable to support a means for communicating with the satellite network entity in accordance with a mode different from the store and forward operation mode based on the combination of the first value indicating that the set of UEs is not barred from communications and the second value indicating that the store and forward operation mode not being supported by the satellite network entity.

In some examples, to support receiving the signaling, the indicator interface 625 is capable of, configured to, or operable to support a means for receiving the first value that indicates that the set of UEs is barred from communications with the satellite network entity and the second value that indicates that the store and forward operation mode is not supported by the satellite network entity.

In some examples, to support receiving the signaling, the indicator interface 625 is capable of, configured to, or operable to support a means for receiving the first value that indicates that the set of UEs is barred from communications with the satellite network entity and the second value that indicates that the store and forward operation mode is active for the communications.

In some examples, to support receiving the signaling, the indicator interface 625 is capable of, configured to, or operable to support a means for receiving the first value that indicates that the set of UEs is barred from communications with the satellite network entity and the second value that indicates that the store and forward operation mode is unavailable for the communications.

In some examples, to support receiving the signaling, the indicator interface 625 is capable of, configured to, or operable to support a means for receiving the first value that indicates that the set of UEs is not barred from communications with the satellite network entity and the second value that indicates that the store and forward operation mode is barred.

In some examples, the combination of the first value and the second value indicates that UEs operating in accordance with the store and forward operation mode are barred.

In some examples, to support receiving the signaling, the indicator interface 625 is capable of, configured to, or operable to support a means for receiving the first value that indicates that cell-barring is unavailable for the set of UEs and the second value that indicates that the store and forward operation mode is active for the satellite network entity.

In some examples, to support receiving the signaling, the indicator interface 625 is capable of, configured to, or operable to support a means for receiving the first value that indicates that cell-barring is unavailable for the set of UEs and the second value that indicates that the store and forward operation mode is inactive for the satellite network entity.

In some examples, to support operating in accordance with the availability, the operation component 640 is capable of, configured to, or operable to support a means for communicating with the satellite network entity in accordance with the store and forward operation mode and receiving from the satellite network entity, signaling that is configured to cause the UE to perform cell search and cell selection for communications in accordance with a mode different from the store and forward operation mode.

In some examples, to support receiving the signaling, the system information interface 645 is capable of, configured to, or operable to support a means for receiving a system information message that includes the first indicator and the second indicator.

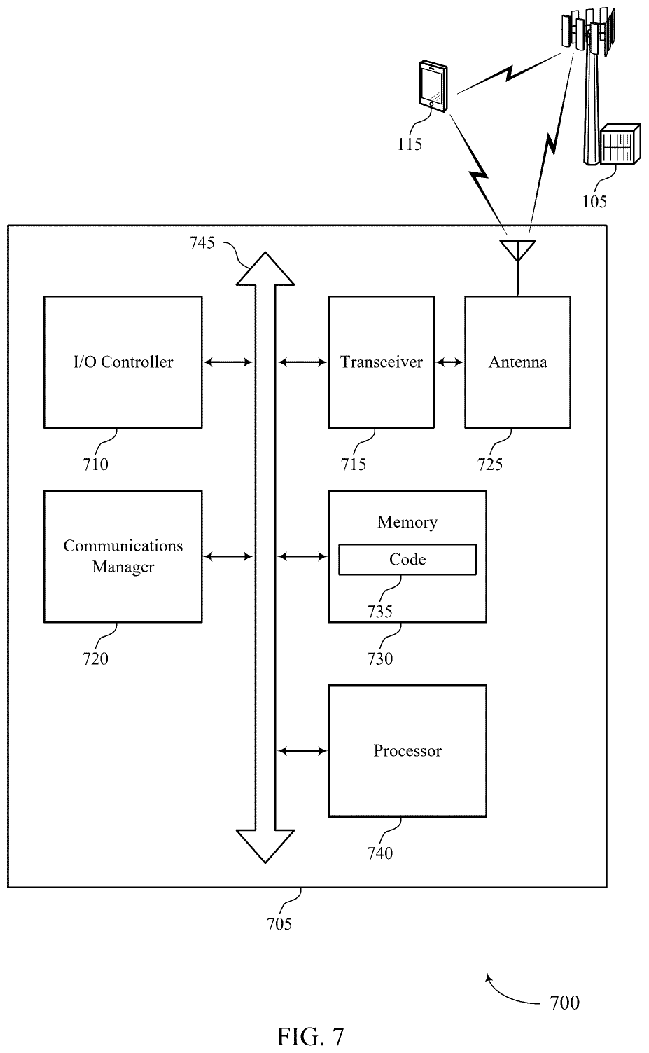

FIG. 7 shows a diagram of a system 700 including a device 705 that supports switching between store and forward and normal mode operations in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller.

In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting switching between store and forward and normal mode operations). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving, from a satellite network entity, signaling including a first indicator of a cell-barred operation status indicative of whether a set of UEs is barred from communications with the satellite network entity and a second indicator of whether a store and forward operation mode is available for communications with the satellite network entity. The communications manager 720 is capable of, configured to, or operable to support a means for evaluating a combination of a first value for the first indicator and a second value of the second indicator. The communications manager 720 is capable of, configured to, or operable to support a means for determining an availability of the satellite network entity for communication with the UE based on the combination of the first value and the second value. The communications manager 720 is capable of, configured to, or operable to support a means for operating in accordance with the availability of the satellite network entity for the communications.

By including or configuring the communications manager 720 in accordance with examples as described herein, the device 705 may support techniques for reduced power and processing resource consumption by providing indications of store and forward mode operations and/or cell-barring status such that UEs may reduce processing, communication, and other resource overhead associated with trying to communicate using a normal mode when such a mode is unavailable for communications.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of switching between store and forward and normal mode operations as described herein, or the at least one processor 740 and the at least one memory 730 may be otherwise configured to, individually or collectively, perform or support such operations.

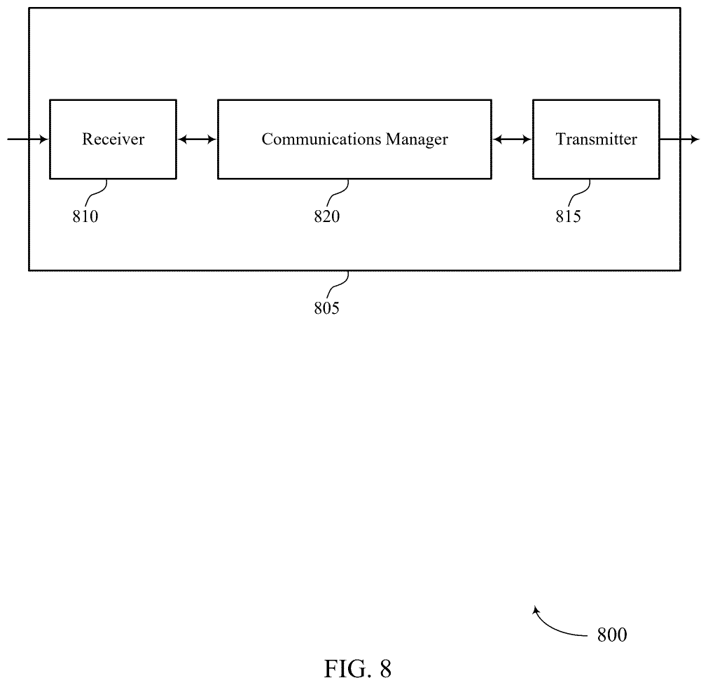

FIG. 8 shows a block diagram 800 of a device 805 that supports switching between store and forward and normal mode operations in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of switching between store and forward and normal mode operations as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for detecting a condition indicative of a change in a connection status of a connection between the satellite network entity and a ground station. The communications manager 820 is capable of, configured to, or operable to support a means for updating, based at least in part on detecting the condition indicative of the change, one or more of a first indicator of a cell-barred operation status indicative of whether a set of UEs is barred from communications with the satellite network entity and a second indicator of whether communications by the satellite network entity are to be performed in accordance with a store and forward operation mode. The communications manager 820 is capable of, configured to, or operable to support a means for transmitting signaling indicative of the updates to one or more of the first indicator and the second indicator.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power and processing resource consumption by providing indications of store and forward mode operations and/or cell-barring status such that UEs may reduce processing, communication, and other resource overhead associated with trying to communicate using a normal mode when such a mode is unavailable for communications.

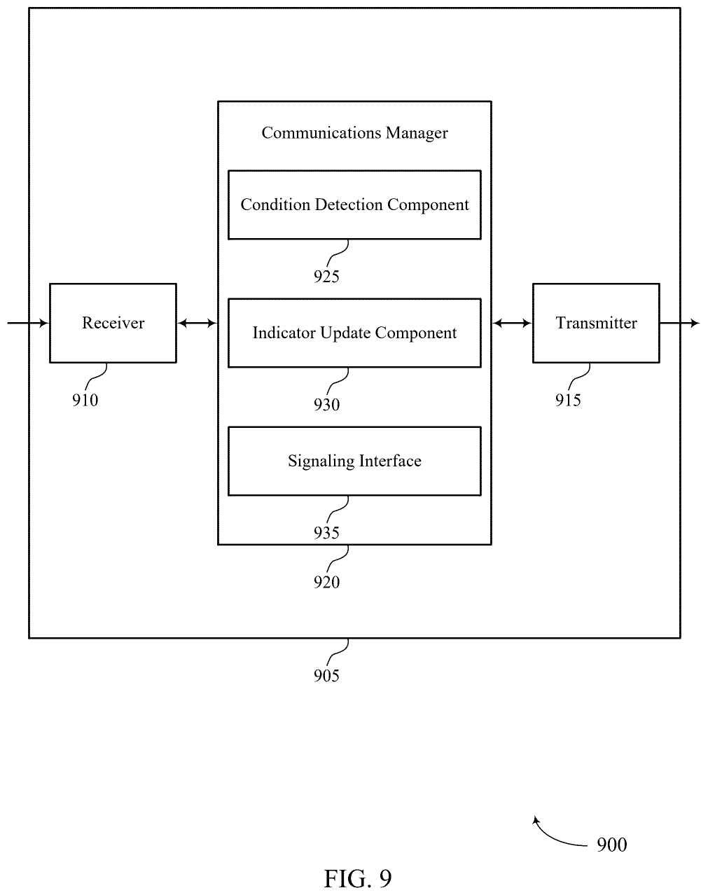

FIG. 9 shows a block diagram 900 of a device 905 that supports switching between store and forward and normal mode operations in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of switching between store and forward and normal mode operations as described herein. For example, the communications manager 920 may include a condition detection component 925, an indicator update component 930, a signaling interface 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The condition detection component 925 is capable of, configured to, or operable to support a means for detecting a condition indicative of a change in a connection status of a connection between the satellite network entity and a ground station. The indicator update component 930 is capable of, configured to, or operable to support a means for updating, based on detecting the condition indicative of the change, one or more of a first indicator of a cell-barred operation status indicative of whether a set of UEs is barred from communications with the satellite network entity and a second indicator of whether communications by the satellite network entity are to be performed in accordance with a store and forward operation mode. The signaling interface 935 is capable of, configured to, or operable to support a means for transmitting signaling indicative of the updates to one or more of the first indicator and the second indicator.

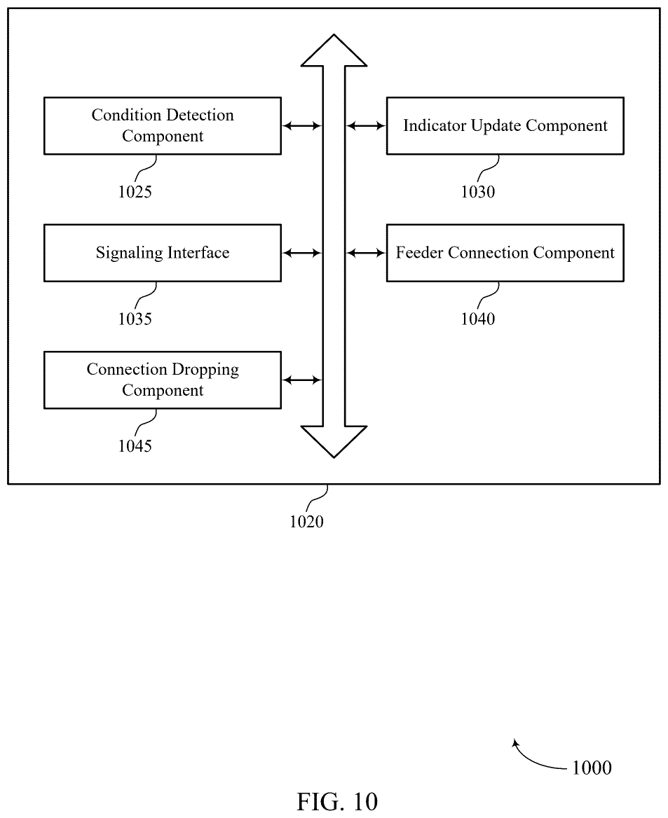

FIG. 10 shows a block diagram 1000 of a communications manager 1020 that supports switching between store and forward and normal mode operations in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of switching between store and forward and normal mode operations as described herein. For example, the communications manager 1020 may include a condition detection component 1025, an indicator update component 1030, a signaling interface 1035, a feeder connection component 1040, a connection dropping component 1045, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The condition detection component 1025 is capable of, configured to, or operable to support a means for detecting a condition indicative of a change in a connection status of a connection between the satellite network entity and a ground station. The indicator update component 1030 is capable of, configured to, or operable to support a means for updating, based on detecting the condition indicative of the change, one or more of a first indicator of a cell-barred operation status indicative of whether a set of UEs is barred from communications with the satellite network entity and a second indicator of whether communications by the satellite network entity are to be performed in accordance with a store and forward operation mode. The signaling interface 1035 is capable of, configured to, or operable to support a means for transmitting signaling indicative of the updates to one or more of the first indicator and the second indicator.

In some examples, to support detecting the condition, the feeder connection component 1040 is capable of, configured to, or operable to support a means for establishing the connection between the satellite network entity and the ground station, where the first indicator is updated to indicate that set of UEs is not barred from the communications, the second indicator is updated to indicate that the store and forward operation mode is inactive, or a combination thereof.

In some examples, to support detecting the condition, the connection dropping component 1045 is capable of, configured to, or operable to support a means for determining that the connection between the satellite network entity and the ground station is to be dropped, where the first indicator is updated to indicate that the set of UEs is barred from the communications, the second indicator is updated to indicate that the store and forward operation mode is active, or a combination thereof.

In some examples, to support transmitting the signaling, the signaling interface 1035 is capable of, configured to, or operable to support a means for transmitting the signaling that releases the set of UEs from a connected state.

In some examples, to support transmitting the signaling, the signaling interface 1035 is capable of, configured to, or operable to support a means for transmitting the signaling to cause a UE to initiate a tracking area update procedure when the store and forward operation mode becomes inactive in response to the connection being established.

In some examples, to support transmitting the signaling, the signaling interface 1035 is capable of, configured to, or operable to support a means for transmitting one or more messages associated with a system information update procedure, where the one or more messages are indicative of the updates to the one or more of the first indicator and the second indicator.

In some examples, to support transmitting the signaling, the signaling interface 1035 is capable of, configured to, or operable to support a means for transmitting an indication of a cell stop time associated with the drop of the connection between the satellite network entity and the ground station.

In some examples, the indication of the cell stop time indicates that the satellite network entity is to operate in accordance with the store and forward operation mode after the cell stop time.

In some examples, the indicator update component 1030 is capable of, configured to, or operable to support a means for obtaining, for a UE, a capability of the UE to operate in accordance with the store and forward operation mode, where the signaling is configured to release the UE from a connected state based at least in part on the capability.

In some examples, to support transmitting the signaling, the signaling interface 1035 is capable of, configured to, or operable to support a means for transmitting a system information message that includes the first indicator and the second indicator.

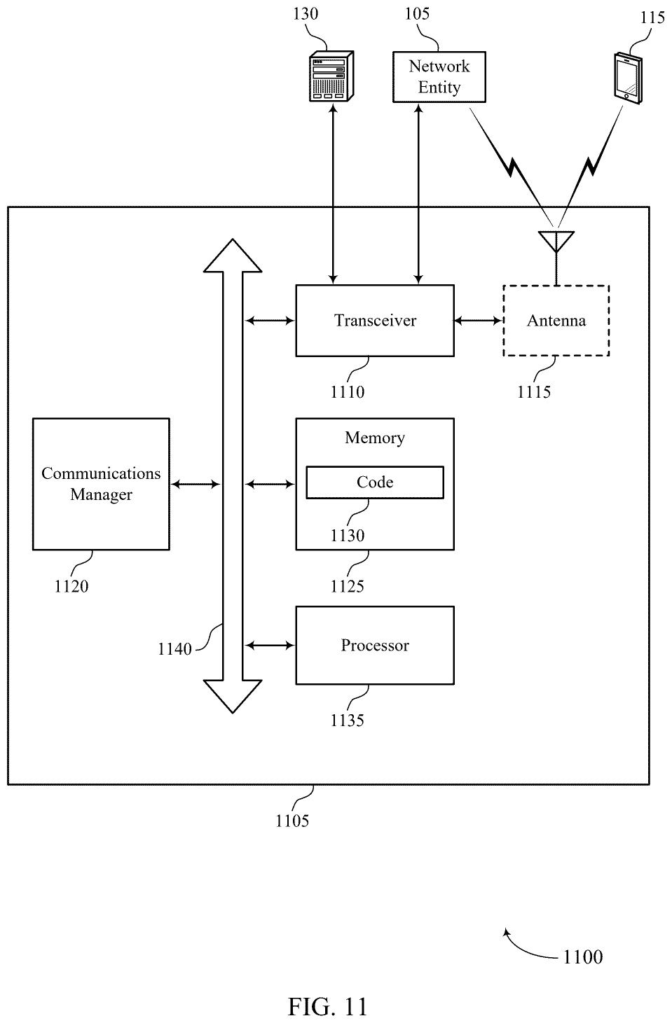

FIG. 11 shows a diagram of a system 1100 including a device 1105 that supports switching between store and forward and normal mode operations in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting switching between store and forward and normal mode operations). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for detecting a condition indicative of a change in a connection status of a connection between the satellite network entity and a ground station. The communications manager 1120 is capable of, configured to, or operable to support a means for updating, based at least in part on detecting the condition indicative of the change, one or more of a first indicator of a cell-barred operation status indicative of whether a set of UEs is barred from communications with the satellite network entity and a second indicator of whether communications by the satellite network entity are to be performed in accordance with a store and forward operation mode. The communications manager 1120 is capable of, configured to, or operable to support a means for transmitting signaling indicative of the updates to one or more of the first indicator and the second indicator.

By including or configuring the communications manager 1120 in accordance with examples as described herein, the device 1105 may support techniques for reduced power and processing resource consumption by providing indications of store and forward mode operations and/or cell-barring status such that UEs may reduce processing, communication, and other resource overhead associated with trying to communicate using a normal mode when such a mode is unavailable for communications.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of switching between store and forward and normal mode operations as described herein, or the at least one processor 1135 and the at least one memory 1125 may be otherwise configured to, individually or collectively, perform or support such operations.

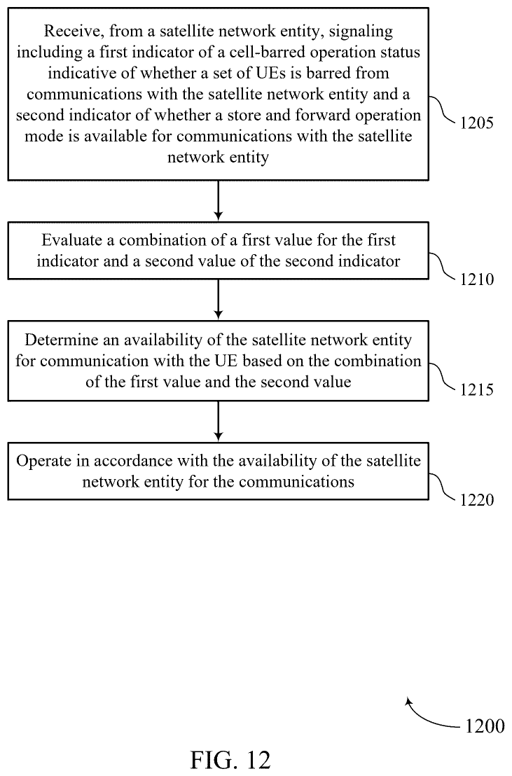

FIG. 12 shows a flowchart illustrating a method 1200 that supports switching between store and forward and normal mode operations in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving, from a satellite network entity, signaling including a first indicator of a cell-barred operation status indicative of whether a set of UEs is barred from communications with the satellite network entity and a second indicator of whether a store and forward operation mode is available for communications with the satellite network entity. The operations of 1205 may be performed in accordance with examples as disclosed herein. In some examples, aspects of the operations of 1205 may be performed by an indicator interface 625 as described with reference to FIG. 6.

At 1210, the method may include evaluating a combination of a first value for the first indicator and a second value of the second indicator. The operations of 1210 may be performed in accordance with examples as disclosed herein. In some examples, aspects of the operations of 1210 may be performed by an indicator evaluation component 630 as described with reference to FIG. 6.

At 1215, the method may include determining an availability of the satellite network entity for communication with the UE based on the combination of the first value and the second value. The operations of 1215 may be performed in accordance with examples as disclosed herein. In some examples, aspects of the operations of 1215 may be performed by a cell availability component 635 as described with reference to FIG. 6.

At 1220, the method may include operating in accordance with the availability of the satellite network entity for the communications. The operations of 1220 may be performed in accordance with examples as disclosed herein. In some examples, aspects of the operations of 1220 may be performed by an operation component 640 as described with reference to FIG. 6.

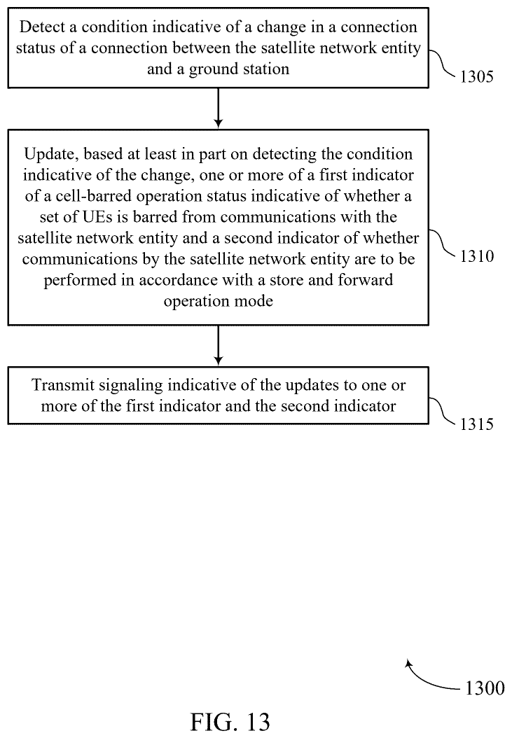

FIG. 13 shows a flowchart illustrating a method 1300 that supports switching between store and forward and normal mode operations in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware. For the purpose of switching between store and forward and normal mode operations, frequency priorities and cell reselection offsets may be configured for UEs, and these parameters may define the procedures to perform measurements for cell reselection. In some examples, the UEs communicating with store and forward mode cells may be configured to move to cells operating in non-store and forward mode. In some examples, UE prioritizes selection to a cell operating in normal mode over a cell operating in store and forward mode. This prioritization may be advantageous for NB-IoT UEs for which frequency priorities may not be considered. Additionally, this prioritization may be used in cases when equal frequency priorities are configured or in cases when a both store and forward mode and normal operation mode cells satisfy cell selection criteria satisfy cell selection criteria. When accessing the cell operating in store and forward mode, the UEs can be configured to periodically search for cells operating in normal mode. When switching between store and forward mode and normal mode, the UE may be configured to trigger registration or TAU update. In some examples, the cells operating in normal mode and store and forward mode may be configured with same the same tracking area or same PLMN, where no TAU or registration update may be performed when switching.

At 1305, the method may include detecting a condition indicative of a change in a connection status of a connection between the satellite network entity and a ground station. The operations of 1305 may be performed in accordance with examples as disclosed herein. In some examples, aspects of the operations of 1305 may be performed by a condition detection component 1025 as described with reference to FIG. 10.

At 1310, the method may include updating, based on detecting the condition indicative of the change, one or more of a first indicator of a cell-barred operation status indicative of whether a set of UEs is barred from communications with the satellite network entity and a second indicator of whether communications by the satellite network entity are to be performed in accordance with a store and forward operation mode. The operations of 1310 may be performed in accordance with examples as disclosed herein. In some examples, aspects of the operations of 1310 may be performed by an indicator update component 1030 as described with reference to FIG. 10.

At 1315, the method may include transmitting signaling indicative of the updates to one or more of the first indicator and the second indicator. The operations of 1315 may be performed in accordance with examples as disclosed herein. In some examples, aspects of the operations of 1315 may be performed by a signaling interface 1035 as described with reference to FIG. 10. In some examples, satellite network entity may establish the satellite feeder link connection (feeder link becomes available) and remove of the store and forward mode indication. In this case, the satellite network entity may not send any notification to UEs (e.g., because UEs supporting store and forward mode operation may also support normal mode operation). However, if a cell-barred indication (e.g., cellBarred-NTN-r17) is changed, procedures may be used to update SIB1. In cases when the satellite feeder link connection is dropped, the satellite network entity may add the store and forward mode indication in SIB. In this case, the network may also release UEs that do not support store forward mode operation in RRC_CONNECTED to IDLE mode. In some case, the base station entity of the satellite network performs the release operation, and the core network entity of the satellite network entity signals the store and forward mode capability information for the UE to the base station. In some cases, the core network entity of the satellite network triggers the release operation. In such cases, it may be desirable to avoid transmitting paging notification to eMTC and NB-IoT UEs. Therefore, a cell stop time mechanism may be used to inform the legacy UEs to identify other cells at the indicated cell stop time. This technique may be used in cases when feeder link is to be dropped or when feeder link is to be established. For UEs supporting store and forward mode operation, an indication (in SIB1 or SIB19) may be introduced to indicate the cell stop time associated with the store and forward mode operation (e.g., at cell stop time, the cell loses feeder link and operates in store and forward operation mode).

The following provides an overview of aspects of the present disclosure:
Aspect 1: A method for wireless communications at a UE, comprising: receiving, from a satellite network entity, signaling comprising a first indicator of a cell-barred operation status indicative of whether a set of UEs is barred from communications with the satellite network entity and a second indicator of whether a store and forward operation mode is available for communications with the satellite network entity; evaluating a combination of a first value for the first indicator and a second value of the second indicator; determining an availability of the satellite network entity for communication with the UE based at least in part on the combination of the first value and the second value; and operating in accordance with the availability of the satellite network entity for the communications.
Aspect 2: The method of aspect 1, wherein determining the availability comprises: determining, based at least in part on the combination of the first value and the second value, an operation mode by the satellite network entity for communication with the UE, wherein the operation mode is determined from the store and forward operation mode and a mode different from the store and forward operation mode
Aspect 3: The method of any of aspects 1 through 2, wherein receiving the signaling comprises: receiving the first value that indicates that the set of UEs is barred from communications with the satellite network entity and the second value that indicates that the store and forward operation mode is available for the communications with the satellite network entity.
Aspect 4: The method of any of aspects 1 through 2, wherein receiving the signaling comprises: receiving the first value that indicates that the set of UEs is not barred from communications with the satellite network entity and the second value that indicates that the store and forward operation mode is available for the communications with the satellite network entity.
Aspect 5: The method of aspect 4, wherein the combination of the first value and the second value indicates that the store and forward operation mode is inactive for the satellite network entity.
Aspect 6: The method of any of aspects 4 through 5, wherein the combination of the first value and the second value indicates that the store and forward operation mode is supported by the satellite network entity and that a feeder link is available by the satellite network entity.
Aspect 7: The method of any of aspects 1 through 6, wherein operating in accordance with the availability comprises: communicating with the satellite network entity in accordance with the store and forward operation mode; and receiving, from the satellite network entity, signaling that is configured to cause the UE to perform cell search and cell selection for communications in accordance with a mode different from the store and forward operation mode.
Aspect 8: The method of any of aspects 1 through 2, wherein receiving the signaling comprises: receiving the first value that indicates that the set of UEs is not barred from communications with the satellite network entity and the second value that indicates that the store and forward operation mode is not supported by the satellite network entity.
Aspect 9: The method of aspect 8, wherein operating in accordance with the availability of the satellite network entity comprises: communicating with the satellite network entity in accordance with a mode different from the store and forward operation mode based at least in part on the combination of the first value indicating that the set of UEs is not barred from communications and the second value indicating that the store and forward operation mode not being supported by the satellite network entity.
Aspect 10: The method of any of aspects 1 through 2, wherein receiving the signaling comprises: receiving the first value that indicates that the set of UEs is barred from communications with the satellite network entity and the second value that indicates that the store and forward operation mode is not supported by the satellite network entity.
Aspect 11: The method of any of aspects 1 through 2, wherein receiving the signaling comprises: receiving the first value that indicates that the set of UEs is barred from communications with the satellite network entity and the second value that indicates that the store and forward operation mode is active for the communications.
Aspect 12: The method of any of aspects 1 through 2, wherein receiving the signaling comprises: receiving the first value that indicates that the set of UEs is barred from communications with the satellite network entity and the second value that indicates that the store and forward operation mode is unavailable for the communications.
Aspect 13: The method of any of aspects 1 through 2, wherein receiving the signaling comprises: receiving the first value that indicates that the set of UEs is not barred from communications with the satellite network entity and the second value that indicates that the store and forward operation mode is barred.
Aspect 14: The method of aspect 13, wherein the combination of the first value and the second value indicates that UEs operating in accordance with the store and forward operation mode are barred.
Aspect 15: The method of any of aspects 1 through 2, wherein receiving the signaling comprises: receiving the first value that indicates that cell-barring is unavailable for the set of UEs and the second value that indicates that the store and forward operation mode is active for the satellite network entity.
Aspect 16: The method of any of aspects 1 through 2, wherein receiving the signaling comprises: receiving the first value that indicates that cell-barring is unavailable for the set of UEs and the second value that indicates that the store and forward operation mode is inactive for the satellite network entity.
Aspect 17: The method of any of aspects 1 through 2, wherein receiving the signaling comprises: receiving a system information message that comprises the first indicator and the second indicator.
Aspect 18: A method for wireless communications at a satellite network entity, comprising: detecting a condition indicative of a change in a connection status of a connection between the satellite network entity and a ground station; updating, based at least in part on detecting the condition indicative of the change, one or more of a first indicator of a cell-barred operation status indicative of whether a set of UEs is barred from communications with the satellite network entity and a second indicator of whether communications by the satellite network entity are to be performed in accordance with a store and forward operation mode; and transmitting signaling indicative of the updates to one or more of the first indicator and the second indicator.
Aspect 19: The method of aspect 18, wherein detecting the condition comprises: establishing the connection between the satellite network entity and the ground station, wherein the first indicator is updated to indicate that set of UEs is not barred from the communications, the second indicator is updated to indicate that the store and forward operation mode is inactive, or a combination thereof.
Aspect 20: The method of aspect 19, wherein transmitting the signaling comprises: transmitting the signaling to cause a UE to initiate a tracking area update procedure when the store and forward operation mode becomes inactive in response to the connection being established
Aspect 21: The method of any of aspects 18 through 20, wherein detecting the condition comprises: determining that the connection between the satellite network entity and the ground station is to be dropped, wherein the first indicator is updated to indicate that the set of UEs is barred from the communications, the second indicator is updated to indicate that the store and forward operation mode is active, or a combination thereof.
Aspect 22: The method of aspect 21, wherein transmitting the signaling comprises: transmitting the signaling that releases the set of UEs from a connected state.
Aspect 23: The method of any of aspects 21 through 22, further comprising: obtaining, for a UE, a capability of the UE to operate in accordance with the store and forward operation mode, wherein the signaling is configured to release the UE from a connected state based at least in part on the capability.
Aspect 24: The method of any of aspects 21 through 23, wherein transmitting the signaling comprises: transmitting one or more messages associated with a system information update procedure, wherein the one or more messages are indicative of the updates to the one or more of the first indicator and the second indicator.
Aspect 25: The method of any of aspects 21 through 24, wherein transmitting the signaling comprises: transmitting an indication of a cell stop time associated with the drop of the connection between the satellite network entity and the ground station.
Aspect 26: The method of aspect 25, wherein the indication of the cell stop time indicates that the satellite network entity is to operate in accordance with the store and forward operation mode after the cell stop time.
Aspect 27: The method of any of aspects 18 through 26, wherein transmitting the signaling comprises: transmitting a system information message that comprises the first indicator and the second indicator.
Aspect 28: A UE for wireless communications, comprising one or more memories storing processor-executable code, and one or more processors coupled with the one or more memories and individually or collectively operable to execute the code to cause the UE to perform a method of any of aspects 1 through 17.
Aspect 29: A UE for wireless communications, comprising at least one means for performing a method of any of aspects 1 through 17.
Aspect 30: A non-transitory computer-readable medium storing code for wireless communications, the code comprising instructions executable by one or more processors to perform a method of any of aspects 1 through 17.
Aspect 31: A satellite network entity for wireless communications, comprising one or more memories storing processor-executable code, and one or more processors coupled with the one or more memories and individually or collectively operable to execute the code to cause the satellite network entity to perform a method of any of aspects 18 through 27.
Aspect 32: A satellite network entity for wireless communications, comprising at least one means for performing a method of any of aspects 18 through 27.
Aspect 33: A non-transitory computer-readable medium storing code for wireless communications, the code comprising instructions executable by one or more processors to perform a method of any of aspects 18 through 27.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a satellite network entity, signaling comprising a first indicator of a cell-barred operation status indicative of whether a set of UEs is barred from communications with the satellite network entity and a second indicator of whether a store and forward operation mode is available for communications with the satellite network entity;
evaluate a combination of a first value for the first indicator and a second value of the second indicator;
determine an availability of the satellite network entity for communication with the UE based at least in part on the combination of the first value and the second value; and
operate in accordance with the availability of the satellite network entity for the communications.

2. The UE of claim 1, to determine the availability, the one or more processors are individually or collectively operable to execute the code to cause the UE to:
determine, based at least in part on the combination of the first value and the second value, an operation mode by the satellite network entity for communication with the UE, wherein the operation mode is determined from the store and forward operation mode and a mode different from the store and forward operation mode.

3. The UE of claim 1, wherein, to receive the signaling, the one or more processors are individually or collectively operable to execute the code to cause the UE to:
receive the first value that indicates that the set of UEs is barred from communications with the satellite network entity and the second value that indicates that the store and forward operation mode is available for the communications with the satellite network entity.

4. The UE of claim 1, wherein, to receive the signaling, the one or more processors are individually or collectively operable to execute the code to cause the UE to:
receive the first value that indicates that the set of UEs is not barred from communications with the satellite network entity and the second value that indicates that the store and forward operation mode is available for the communications with the satellite network entity.

5. The UE of claim 4, wherein the combination of the first value and the second value indicates that the store and forward operation mode is inactive for the satellite network entity.

6. The UE of claim 4, wherein the combination of the first value and the second value indicates that the store and forward operation mode is supported by the satellite network entity and that a feeder link is available by the satellite network entity.

7. The UE of claim 1, wherein, to operate in accordance with the availability of the satellite network entity, the one or more processors are individually or collectively operable to execute the code to cause the UE to:
communicate with the satellite network entity in accordance with the store and forward operation mode; and
receive, from the satellite network entity, signaling that is configured to cause the UE to perform cell search and cell selection for communications in accordance with a mode different from the store and forward operation mode.

8. The UE of claim 1, wherein, to receive the signaling, the one or more processors are individually or collectively operable to execute the code to cause the UE to:
receive the first value that indicates that the set of UEs is not barred from communications with the satellite network entity and the second value that indicates that the store and forward operation mode is not supported by the satellite network entity.

9. The UE of claim 8, wherein, to operate in accordance with the availability of the satellite network entity, the one or more processors are individually or collectively operable to execute the code to cause the UE to:
communicate with the satellite network entity in accordance with a mode different from the store and forward operation mode based at least in part on the combination of the first value indicating that the set of UEs is not barred from communications and the second value indicating that the store and forward operation mode not being supported by the satellite network entity.

10. The UE of claim 1, wherein, to receive the signaling, the one or more processors are individually or collectively operable to execute the code to cause the UE to:
receive the first value that indicates that the set of UEs is barred from communications with the satellite network entity and the second value that indicates that the store and forward operation mode is not supported by the satellite network entity.

11. The UE of claim 1, wherein, to receive the signaling, the one or more processors are individually or collectively operable to execute the code to cause the UE to:
receive the first value that indicates that the set of UEs is barred from communications with the satellite network entity and the second value that indicates that the store and forward operation mode is active for the communications.

12. The UE of claim 1, wherein, to receive the signaling, the one or more processors are individually or collectively operable to execute the code to cause the UE to:
receive the first value that indicates that the set of UEs is barred from communications with the satellite network entity and the second value that indicates that the store and forward operation mode is unavailable for the communications.

13. The UE of claim 1, wherein, to receive the signaling, the one or more processors are individually or collectively operable to execute the code to cause the UE to:
receive the first value that indicates that the set of UEs is not barred from communications with the satellite network entity and the second value that indicates that the store and forward operation mode is barred.

14. The UE of claim 13, wherein the combination of the first value and the second value indicates that UEs operating in accordance with the store and forward operation mode are barred.

15. The UE of claim 1, wherein, to receive the signaling, the one or more processors are individually or collectively operable to execute the code to cause the UE to:
receive a system information message that comprises the first indicator and the second indicator.

16. A satellite network entity, comprising:
one or more memories storing processor-executable code; and
one or more processors coupled with the one or more memories and individually or collectively operable to execute the code to cause the satellite network entity to:
detect a condition indicative of a change in a connection status of a connection between the satellite network entity and a ground station;
update, based at least in part on detecting the condition indicative of the change, one or more of a first indicator of a cell-barred operation status indicative of whether a set of UEs is barred from communications with the satellite network entity and a second indicator of whether communications by the satellite network entity are to be performed in accordance with a store and forward operation mode; and
transmit signaling indicative of the updates to one or more of the first indicator and the second indicator.

17. The satellite network entity of claim 16, wherein, to detect the condition, the one or more processors are individually or collectively operable to execute the code to cause the satellite network entity to:
establish the connection between the satellite network entity and the ground station, wherein the first indicator is updated to indicate that set of UEs is not barred from the communications, the second indicator is updated to indicate that the store and forward operation mode is inactive, or a combination thereof.

18. The satellite network entity of claim 17, wherein, to transmit the signaling, the one or more processors are individually or collectively operable to execute the code to cause the satellite network entity to:
transmit the signaling to cause a UE to initiate a tracking area update procedure when the store and forward operation mode becomes inactive in response to the connection being established.

19. The satellite network entity of claim 16, wherein, to detect the condition, the one or more processors are individually or collectively operable to execute the code to cause the satellite network entity to:
determine that the connection between the satellite network entity and the ground station is to be dropped, wherein the first indicator is updated to indicate that the set of UEs is barred from the communications, the second indicator is updated to indicate that the store and forward operation mode is active, or a combination thereof.

20. A method for wireless communications at a user equipment (UE), comprising:
receiving, from a satellite network entity, signaling comprising a first indicator of a cell-barred operation status indicative of whether a set of UEs is barred from communications with the satellite network entity and a second indicator of whether a store and forward operation mode is available for communications with the satellite network entity;
evaluating a combination of a first value for the first indicator and a second value of the second indicator;
determining an availability of the satellite network entity for communication with the UE based at least in part on the combination of the first value and the second value; and
operating in accordance with the availability of the satellite network entity for the communications.
